(19) United States
(12) Patent Application Publication
(10) Pub. No.: US 2020/0402263 A1
(43) Pub. Date: Dec. 24, 2020

(54) PROCESSING IMAGES

(71) Applicant: Hewlett-Packard Development Company, L.P., Spring, TX (US)

(72) Inventors: Bradley R Larson, Boise, ID (US); John Harris, Boise, ID (US); Eugene A Roylance, Boise, ID (US); Mary T Prenn, Boise, ID (US); Paul N Ballard, Boise, ID (US); Trace A Griffiths, Boise, ID (US)

(21) Appl. No.: 16/975,231

(22) PCT Filed: Mar. 19, 2018
(86) PCT No.: PCT/US2018/023058

§ 371 Date: Aug. 24, 2020

(51) Int. Cl. G06T 9/00; G06T 3/40; G06T 1/60; G06T 1/20

(52) U.S. Cl. CPC G06T 9/00; G06T 1/20; G06T 1/60; G06T 3/40

(57) ABSTRACT

An example image device includes a compressor to compress image data from a row-and-column format into non-overlapping tiles including blocks of pixels, a processor to write the blocks of pixels one tile at a time in a column-wise manner across an image strip to create image data, and an on-chip memory to store the image data.

### BACKGROUND

Image processing techniques typically utilize firmware resources for proper processing of the image data. The type of processing technique varies across different types of image devices or machines. For example, low-end devices and high-end devices typically utilize different processing techniques to process image data and without utilizing the same processing technique for the different types of devices.

### BRIEF DESCRIPTION OF THE DRAWINGS

The following detailed description references the drawings, wherein:

FIG. 1 is a block diagram illustrating an image device for processing images, according to an example.

FIG. 2 is a block diagram illustrating a decompressor used in accordance with the image device of FIG. 1 for processing images, according to an example.

FIG. 3 is a block diagram illustrating an exemplary block size for blocks of pixels arranged for low-end implementations, according to an example.

FIG. 4 is a block diagram illustrating the on-chip memory of the image device of FIG. 1 for processing images, according to an example.

FIG. 5 is a block diagram illustrating processor functions of the image device of FIG. 1 in relation to memory external to the on-chip memory, according to an example.

FIG. 6 is a flow diagram illustrating an image processing technique for low-end implementations, according to an example.

FIG. 7 is a flow diagram illustrating an image processing technique for high-end implementations, according to an example.

FIG. 8 is a block diagram illustrating an image engine for processing images, according to an example.

FIG. 9 is a block diagram illustrating image pipeline functions of the image engine of FIG. 8 in relation to memory external to the circuit chip, according to an example

FIG. 10 is a block diagram illustrating aspects of the memory device of the image engine of FIG. 8 for processing images, according to an example.

FIG. 11 is a block diagram illustrating an image processing technique of the image pipeline of FIG. 8, according to an example.

FIG. 12 is a block diagram illustrating the non-overlapping micro-columns of the image data, according to an example.

FIG. 13 is a block diagram illustrating the image pipeline of FIG. 8, according to an example.

FIG. 14 is a block diagram illustrating processing of the image strip of the image pipeline of FIG. 8, according to an example.

FIG. 15 is a block diagram illustrating an image data processing sequence, according to an example.

FIG. 16 is a block diagram illustrating data processing for low-end performance implementations, according to an example.

FIG. 17 is a block diagram illustrating data processing for high-end performance implementations, according to an example.

FIG. 18 is a block diagram illustrating data management between columns of an image strip, according to an example.

FIG. 19 is a block diagram illustrating a system to process image data on an image device, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In very low-end image devices, such as inkjet or laser printers, column-based print pipeline architectures are used to create very low-cost print systems. In high-end printer products, full width solution architectures are provided for high-performance, richer feature set, and autonomous operation. Providing for a standard image processing technique for both types of classes of image device products; i.e., low-end and high-end products, is an elusive goal in the image processing industry. Image pipeline processing of full-image width strips down the page and all four colors in parallel; e.g., cyan, magenta, yellow and key/black; e.g., CMYK. The image pipeline hardware is sized to support maximum width, with fully buffered lines of data, using independent blocks for each plane of color being processed. This yields a very high-performance of the image processing; however, it tends to require a significant amount of logic gates, large memories, and typically takes a lot of application specific integrated circuit (ASIC) area, which results in higher device costs. Moreover, this high-performance technique, while offering good image processing quality, typically is designed for the highest performance point and, thus, is often underutilized in many products that are not configured to operate at the highest end of performance.

Furthermore, other image pipeline processing techniques process half-width, or third-width, strips of one color at a time, under firmware direction using scripts executed by a dedicated smart direct memory access controller such as a time division multiplexed pipeline (TDMP) controller. The image pipeline hardware is time-shared between planes and processes overlapping columns of the image to support different-sized print media; e.g., A3 vs. A4 media. While this approach saves cost, it may require greater print management complexity and system overhead for context switching.

In order to address this, the examples described below combine the goals identified above to create one system that can be scaled up and down in performance and features, while also using configurable hardware implementations to maximize engineering resources in both hardware and firmware. In particular, the examples described herein provide a hardware-enabled technique to process image data for an image device by compressing an image into smaller non-overlapping tiles or micro-columns of the image. The tiles may be scalable from as small as 8×8 blocks. The tiles do not have to be square, as they could also be rectangular, etc. The image engine processes the micro-columns sequentially in a column-by-column or block-by-block manner across an image strip. The image data is stored on-chip in static random-access memory (SRAM), for example, without utilizing external memory resources. In examples, the image data may include any of print data, scan data, and image data. The technique avoids using firmware resources to process the image data, thereby reducing the complexity of the image processing as well as the allowing for scalability in the size and resolution capabilities.

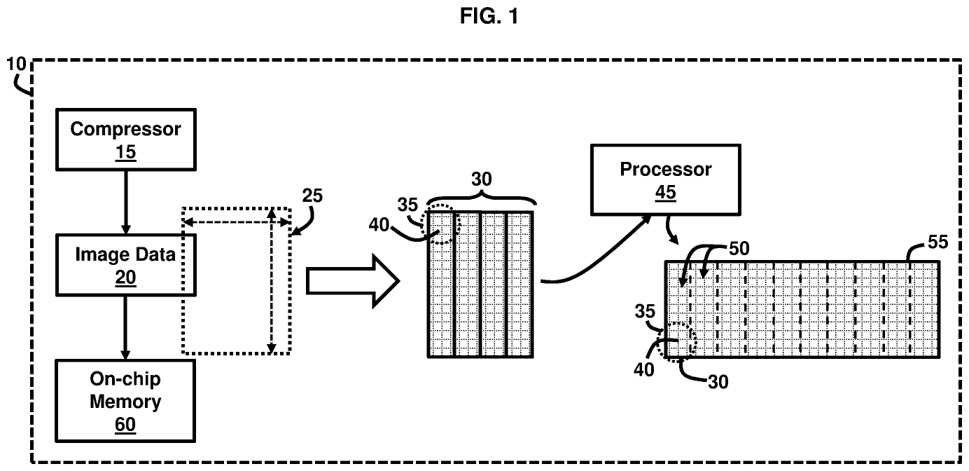

FIG. 1 is a block diagram illustrating an image device 10 comprising a compressor 15 to compress image data 20 from a row-and-column format 25 into non-overlapping tiles 30 comprising blocks 35 of pixels 40. For clarity, a small number of such pixels 40 are illustrated, although it is understood that such pixels 40 exist throughout the image data 20 in the tiles 30. According to some examples, the image device 10 may be a printer, scanner, copier, fax machine, or any other type of electronic device that processes images and image data 20. In an example, the compressor 15 may be configured to compress a variety of different formats of the image data 20; e.g., depending on the color, resolution, and other parameters associated with different types of the image data 20. The compressor 15 may utilize one or more of a variety of different compression techniques such as, for example, JPEG, LZW, LZ77, PPM, etc. A processor 45 is to write the blocks 35 of pixels 40 one tile 30 at a time in a column-wise (e.g., columnar) manner 50 across an image strip 55 to create image data 20. In an example, the processor 45 may include a central processing unit, microprocessors, hardware engines, hardware pipelines, and/or other hardware-enabled devices suitable for running firmware or other computer-executable instructions. An on-chip memory 60 is to store the image data 20. The on-chip memory 60 may provide data storage and retrieval capabilities, according to an example.

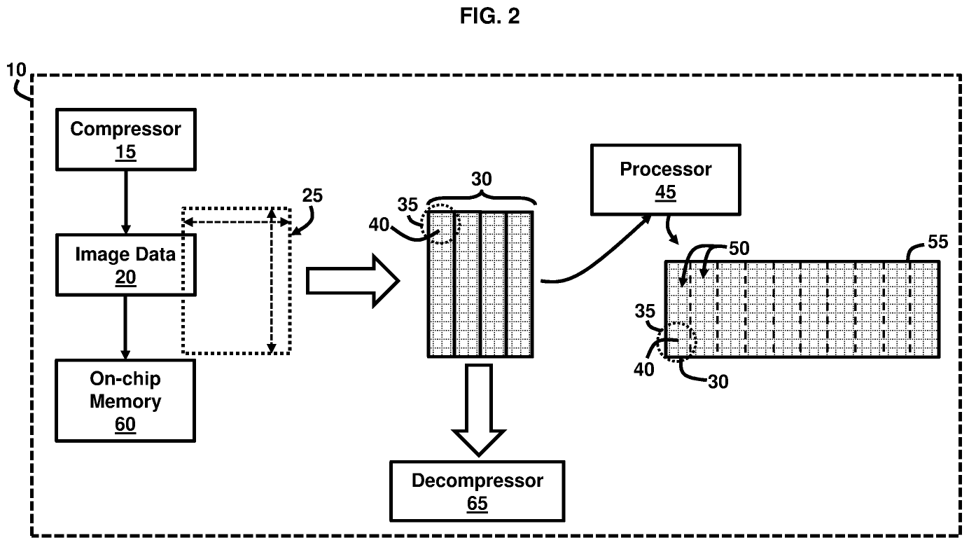

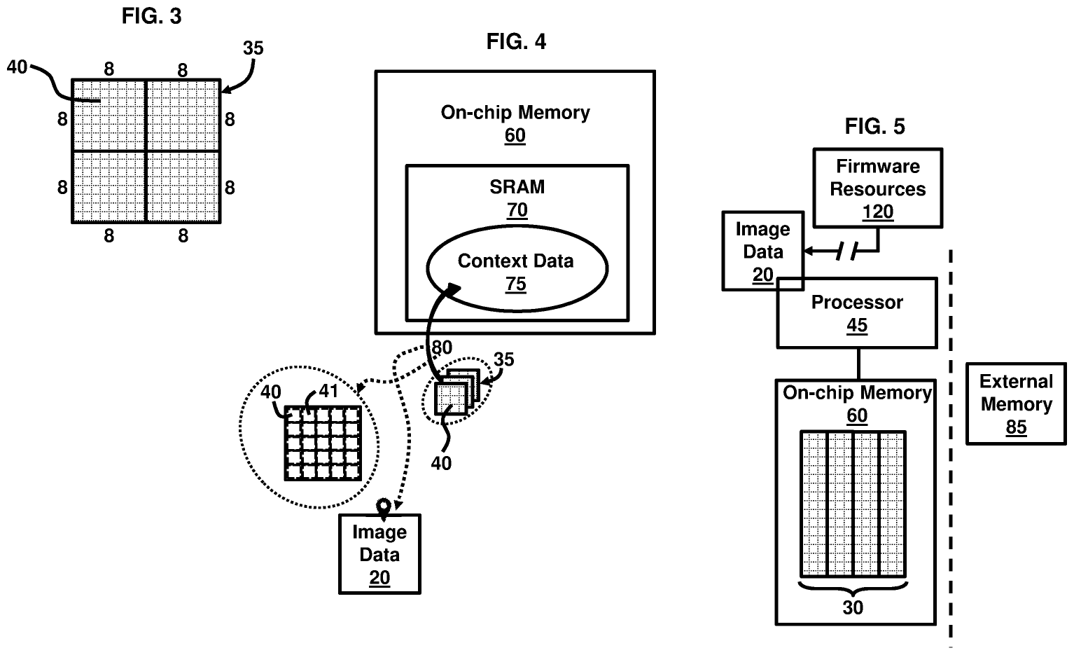

As shown in FIG. 2, with reference to FIG. 1, the image device 10 may comprise a decompressor 65 to decompress the blocks 35 of pixels 40. The decompressor 65 may, in an example, include any suitable decompressing technique or device used for decompressing data into a useable format. As shown in FIG. 3, with reference to FIGS. 1 and 2, in an example, the blocks 35 of pixels 40 may be sized to be at least 8×8 blocks. Such a size may provide very low-end image devices the option to be very lean and low-cost. Moreover, the blocks 35 of pixels 40 may be scaled up in size to any suitable size that the processor 45 is capable of processing and which the particular application demands. In one example, the size may be scaled up to 512×256 pixel blocks. In another example, the size may be scaled up to 512×512 pixel blocks. Such sizes may provide a good balance between the on-chip memory 60 getting too large while also providing low-overhead, high-efficiency processing of the image data 20 for high-performance devices. However, these sizes are merely examples, and as such the blocks 35 of pixels 40 may be suitably sized based on the processing capabilities of the processor 45 and the specific application demands.

In an example shown in FIG. 4, with reference to FIGS. 1 through 3, the on-chip memory 60 may comprise a random-access memory device, and more specifically static random-access memory (SRAM) 70. The on-chip memory 60 may store block context data 75 to providing contextual information 80 regarding each block 35 of pixels 40. For example, the block context data 75 that provides the contextual information 80 may contain information regarding neighboring pixels of the pixels 40, and the location of the image data 20. In an example, the block context data 75 for all block-to-block, strip-to-strip, and plane-to-plane (e.g., CMYK) data may be stored on the on-chip memory 60. This reduces system management complexity such that all classes of products; e.g., low-end devices and high-end devices, appear the same to the firmware for image processing, and it would make no difference whether the device is running in the highest performance mode or in the lowest cost (i.e., TDMP), mode, etc. As such, the hardware processor 45 autonomously manages the different configurations and block sizes used, and thus the system firmware does not have to manage this complexity of the image processing. As shown in FIG. 5, with reference to FIGS. 1 through 4, the processor 45 may prevent the tiles 30 from being stored on memory 85 external to the on-chip memory 60. This further assists in alleviating firmware resources 120 for performing the image processing on the image data 20.

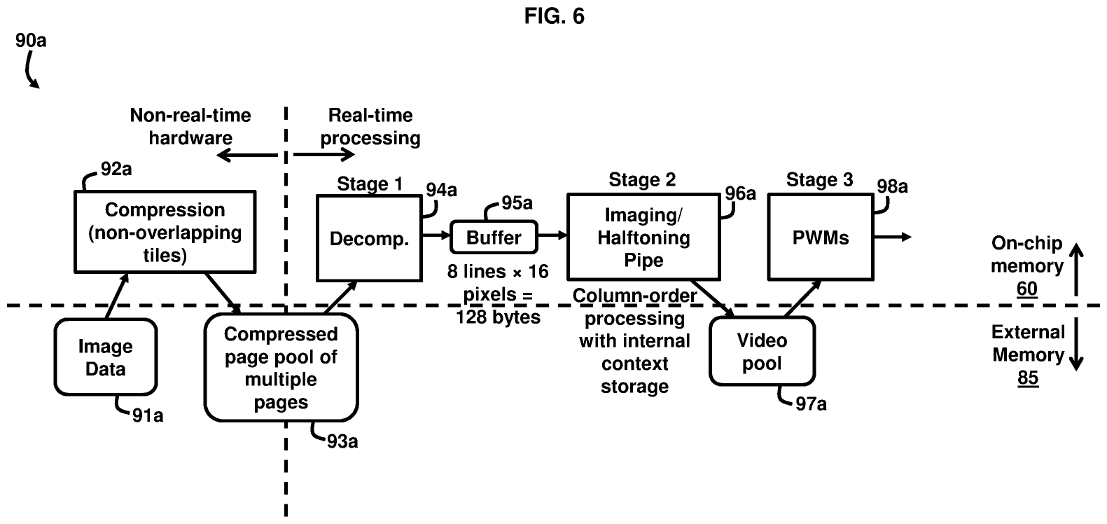

FIG. 6, with reference to FIGS. 1 through 5, illustrates a flow diagram 90a of an example implementation of image device 10 for low-end requirements. As shown in 91a, the image data 20 is provided on memory 85. The image data 20 then undergoes a compression process in 92a using the non-overlapping tiles 30 on the on-chip memory 60. Next, in 93a, the compressed page pool of multiple pages of data is stored on memory 85. As indicated in FIG. 6, 91a, 92a, and part of 93a may be considered non-real-time hardware processing. The remaining processes of the flow diagram 90a may be considered real-time processing. Next, in Stage 1 of the real-time processing of the image data 20, the compressed page pool of multiple pages of data undergoes a decompression process in 94a on the on-chip memory 60. Next, in 95a, the data is stored in a buffer on the on-chip memory 60, wherein the lowest-end requirements may include 1 buffer×8 lines×16 pixels=128 bytes of data. The buffer may format the image data 20 that is to be printed or copied, for example. As such, the decompression process in 94a is performed on short; e.g., 8-line, buffers in 95a, which is fed directly to Stage 2. In Stage 2 of the real-time processing as shown in 96a, the 8×8 pixel blocks undergo imaging/halftoning in processor 45 using column-order processing with internal context storage on the on-chip memory 60. The data is then transferred to a video pool component in 97a on memory 85, and then in Stage 3 of the real-time processing, the image data 20 is once again back on the on-chip memory 60 in a pulse width modulator (PWM), as indicated in 98a.

Accordingly, the architecture provided in FIG. 6 supports multi-pass processing for columns and planes for each image. As such, the architecture provided in FIG. 6 is time-shared to produce each full-width strip of output by processing sequential 8×8 pixel blocks, for example, of each plane automatically. The firmware of the image device 10 sees this process as a single operation producing a full strip of one color, and as such no firmware management is needed, and no special overlapping compression technique is needed. Accordingly, because less system overhead is used, the overall system performance of the image device 10 is improved.

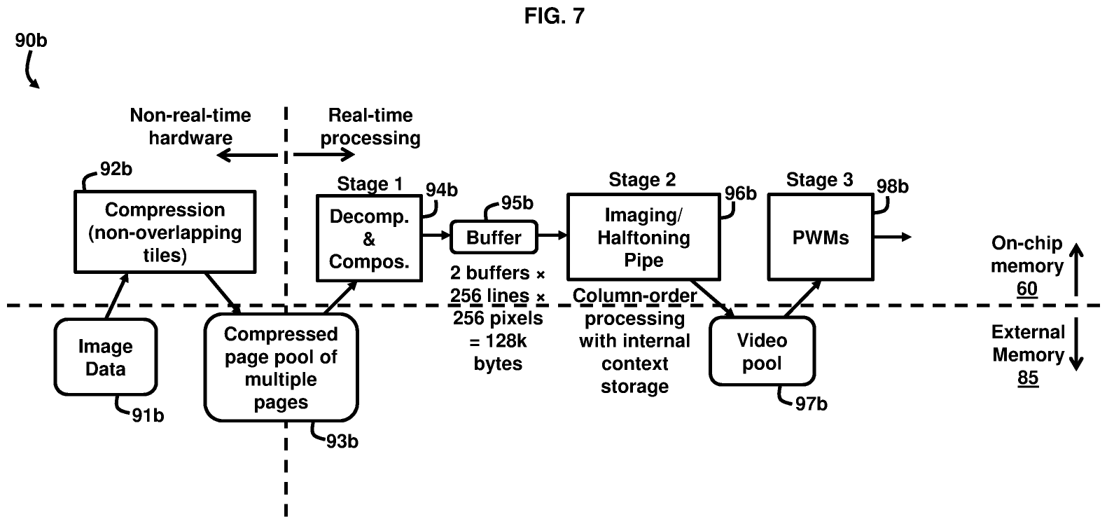

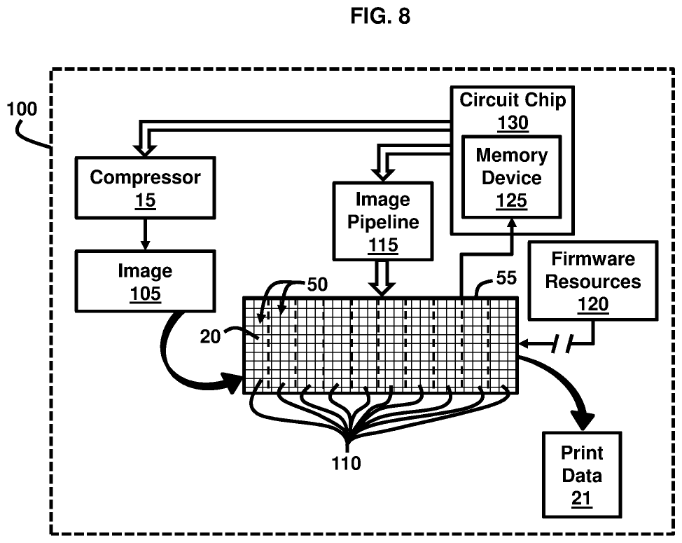

FIG. 7, with reference to FIGS. 1 through 6, illustrates a flow diagram 90b of an example implementation of image device 10 for high-end requirements. As shown in 91b, the image data 20 is provided on memory 85. The image data 20 then undergoes a compression process in 92b using the non-overlapping tiles 30 on the on-chip memory 60. Next, in 93b, the compressed page pool of multiple pages of data is stored on memory 85. As indicated in FIG. 7, 91b, 92b, and part of 93b may be considered non-real-time hardware processing. The remaining processes of the flow diagram 90b may be considered real-time processing. Next, in Stage 1 of the real-time processing of the image data 20, the compressed page pool of multiple pages of data undergoes a decompression and composition process in 94b on the on-chip memory 60. Next, in 95b, the data is stored in two buffers on the on-chip memory 60, wherein the high-end requirements may include 2 buffers×256 lines×256 pixels=128 kilobytes of data. The buffer may format the image data 20 that is to be printed or copied, for example. As such, in this example of 256×256 pixels, the decompression process in 94b is performed on blocks of image data 20, which are collected into micro-columns 110, which is further described below in reference to FIG. 8, and then provided to buffers in 95b, which are fed sequentially to Stage 2. In Stage 2 of the real-time processing as shown in 96b, the 256×256 pixel blocks undergo imaging/halftoning in processor 45 using column-order processing with internal context storage on the on-chip memory 60. The data is then transferred to a video pool component in 97b on memory 85, and then in Stage 3 of the real-time processing, the image data 20 is once again back on the on-chip memory 60 in a pulse width modulator (PWM), as indicated in 98b.

Accordingly, by changing the configuration of the on-chip memory 60 by utilizing SRAM 70 and replicating elements of Stage 2 as indicated in 96b, the architecture provided in FIG. 7 supports single-pass processing for full width image strips 55, for all CMYK color planes, and for various combinations of these processing techniques. As such, the architecture provided in FIG. 7 allows for the processor 45 to run four planes; e.g., CMYK, in parallel to produce each full-width image strip 55 of output by processing sequential 256×256 pixel blocks which are processed by Stage 2. This larger block of data supports the composition operations and associated higher performance requirements. The firmware of the image device 10 sees this process as a single operation producing a full strip of four colors, and as such no firmware management is needed. Accordingly, because no system overhead is used, the overall system performance of the image device 10 is further improved.

FIG. 8, with reference to FIGS. 1 through 7, illustrates another example that provides an image engine 100 comprising a compressor 15 to downscale an image 105 into configurable non-overlapping micro-columns 110 of image data 20 arranged on an image strip 55. As defined herein, the image engine 100 includes a variety of hardware elements, software applications, or a combination of both, that are used to coordinate the overall operation of all processes and functions of other components and applications managed by the image engine 100 and part of an overall system or sub-system. An image pipeline 115 is to sequentially process the micro-columns 110 of image data 20 in a columnar manner 50 across the image strip 55 to create print data 21 without utilizing firmware resources 120 to process the image data 20. As defined herein the image pipeline 115 may be broadly understood to mean a processing element in which stages thereof execute; e.g., in hardware, software, or a combination of both, substantially in parallel on different transformations of the image data 20 which are serially forwarded through the pipeline from stage to stage. The image pipeline 115 may be dynamically programmed to process the image strip 55 in the columnar manner 50. The number of micro-columns 110 to be processed for the image strip 55 may be selectively chosen by the image pipeline 115 based on the media size, the print resolution, and a predetermined width of the image 105. By varying the number of micro-columns 110 to be processed for an image strip 55, different combinations of media size and print resolution can be accommodated by the image pipeline 115. The processing of the micro-columns 110 in sequence across the image strip 55 provides that from final image compression, through decompression, image processing, and halftoning, the image strip 55 is processed in a micro-column 110 order. A memory device 125 is to store the micro-columns 110. A circuit chip 130 is to control the compressor 15 and the image pipeline 115, and to host the memory device 125.

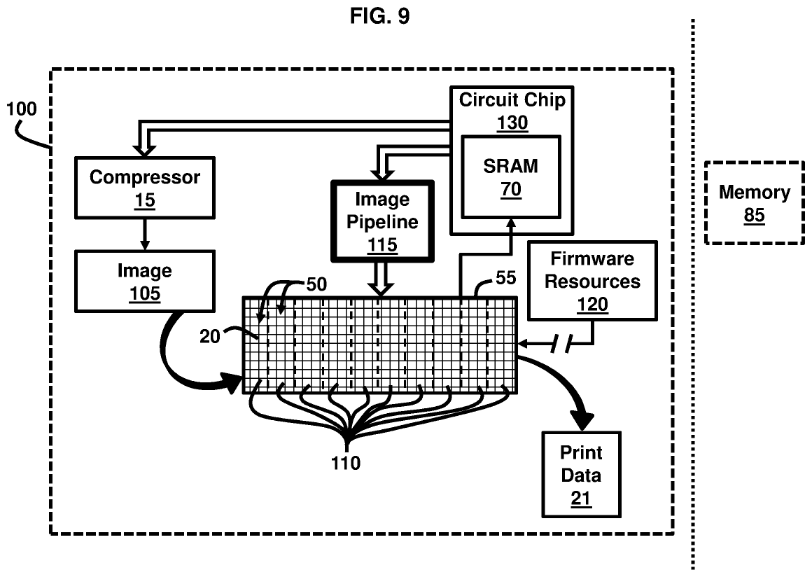

As indicated in FIG. 9, with reference to FIGS. 1 through 8, the image pipeline 115 may prevent the configurable non-overlapping micro-columns 110 from being stored on memory 85 external to the circuit chip 130. As such, to reduce shared system resource demands such as double data rate (DDR) memory bandwidth and central processing unit (CPU) interrupts and cycles, etc., most of the image data 20 that would have ordinarily passed through to the memory 85 that is external to the circuit chip 130 is moved on-chip; e.g., on the circuit chip 130 into static random-access memory (SRAM) 70, for example. In an example, the size of the SRAM 70 may be optimized based on the speed and other configurations of the image engine 100 in order to reduce costs of the overall system. According some examples, the amount of storage capacity in SRAM 70 may correspond to a predetermined maximum width of the micro-columns 110 that can be processed by the image pipeline 115.

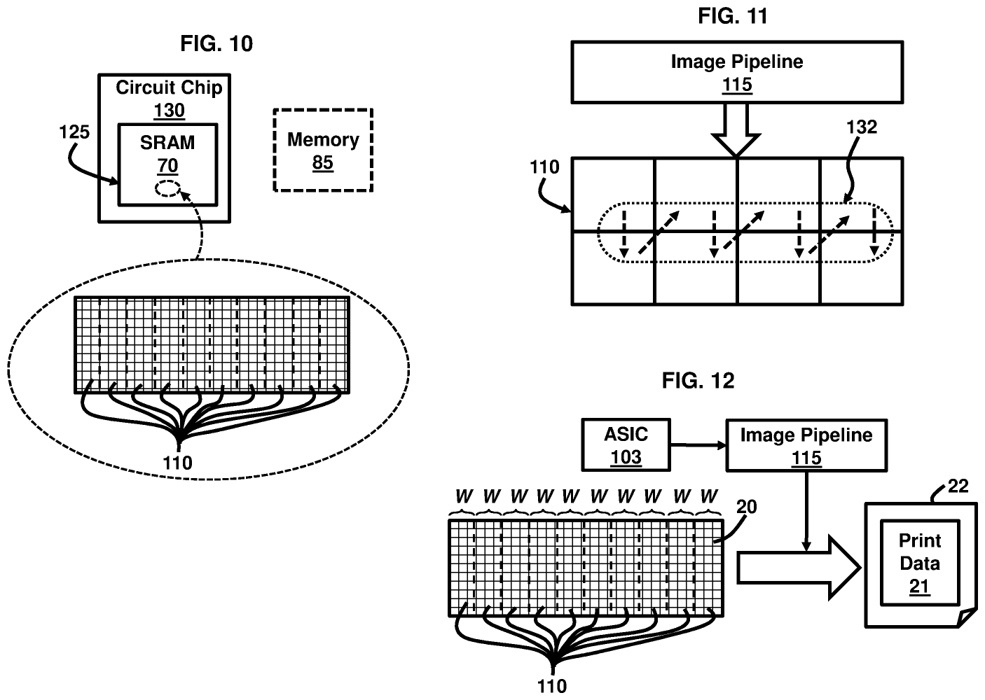

Accordingly, as shown in FIG. 10, with reference to FIGS. 1 through 9, the memory device 125 may comprise SRAM 70 to obviate the need for utilization of memory 85 that is external to the circuit chip 130 because the micro-columns 110 are relatively small blocks instead of larger strips and can be completely contained in the SRAM 70. As shown in FIG. 11, with reference to FIGS. 1 through 10, the image pipeline 115 may sequentially process the micro-columns 110 in a zig-zag manner 132. Furthermore, in an example, each of the non-overlapping micro-columns 110 may comprise an equal width W, as shown in FIG. 12, with reference to FIGS. 1 through 11. In an example, the image engine 100, when configured as a print engine, is provided to deposit a particular color; e.g., one of CMYK colors, on a print medium 22 to form print data 21. The print medium may be any type of suitable sheet or roll material, such as paper, card stock, cloth or other fabric, plastic sheets, transparencies, Mylar® film, etc. In an example, an ASIC 103 may implement the image pipeline 115 for converting the image data 20 into print data 21 for the image engine 100.

In an example, the image pipeline 115 is configured to be dynamically reprogrammed for each of the micro-columns 110 by loading into the image pipeline 115 previously-saved data associated with the micro-columns 110 from memory 85 before the micro-columns 110 are processed, and saving modified data associated with the micro-columns 110 in the memory 85 after the print data 21 for the micro-columns 110 is generated. Configuring the image pipeline 115 may include, according to an example, setting up various control registers and tables of the image pipeline 115 and initializing the various sub-stages of the image pipeline 115 for processing the micro-columns 110.

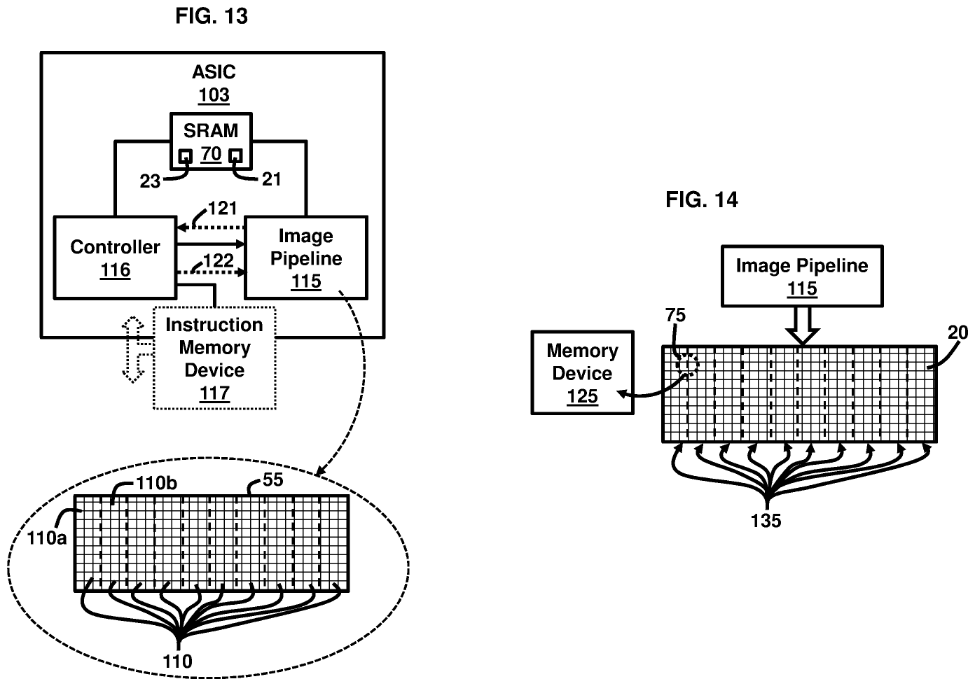

As shown in the example of FIG. 13, with reference to FIGS. 1 through 12, the image pipeline 115 may be controlled by a controller 116, which may be a microcontroller implemented in the ASIC 103 that includes the image pipeline 115. The controller 116 is configured to execute at least one instruction stream stored in an instruction memory device 117 accessible by the controller 116 to dynamically reprogram the image pipeline 115 to serially process each of the micro-columns 110 of a selected image strip 55. According to some examples, the instruction memory device 117 may be located within the ASIC 103, or may be a component external to the ASIC 103 and communicatively coupled to the ASIC 103. The controller 116 may access the SRAM 70 in the ASIC 103, in an example, whereby the SRAM 70 may be used for storing data generated and used by the image pipeline 115.

Following configuration, the image pipeline 115 processes the micro-columns 110, generates print data 21, and stores the print data 21 in the SRAM 70 for the appropriate image strip 55. The processing of the image pipeline 115 may be initiated by the controller 116 signaling the image pipeline 115 to process the micro-columns 110. While the image pipeline 115 is processing the micro-columns 110 to generate print data 21, the controller 116 waits for a first signal 121 from the image pipeline 115 to indicate that processing of a particular micro-column 110a has been completed. After the print data 21 has been generated and stored in SRAM 70, the image pipeline 115 sends a second signal 122 to the controller 116 indicating that the processing of micro-columns 110 has been completed. In response, the controller 116 saves, in the SRAM 70, data 23 usable for processing the next micro-column 110b in sequence.

The width W of the micro-columns 110 may be configured to reduce the overall cost of the image engine 100 by reducing the amount of memory and logic components internal and external to the ASIC 103, with little or no decrease in image processing throughput provided by the image pipeline 115. In an example, the same ASIC 103 or processing elements of the image pipeline 115 and controller 116 can be used in a variety of image devices; e.g., from low-end devices to high-end devices, having a range of different media size, print resolution, and other imaging throughput requirements. In addition, by increasing the number of micro-columns 110 in an image strip 55, the ASIC 103 can be used to print, e.g., on a printer, on newer and larger media sizes, and at newer and increased printing resolutions, as those requirements continue to develop.

The image pipeline 115 may process all context data 75 between columns 135 in the image strip 55, as shown in FIG. 14, with reference to FIGS. 1 through 13. Accordingly, the context data 75 is stored on the memory device 125. This allows the image pipeline 115 to completely maintain all of the image data 20 and context data 75 necessary to switch from one micro-column 110 to the next or one block to the next without utilizing a high firmware resource-demanding save and restore cycle. Accordingly, the firmware of the image pipeline 115 does not have to perform a context switch at all. This also means that firmware no longer has to manage overlapping columns since image pipeline 115 utilizes non-overlapping columns 110. Traditionally, overlapping columns cause challenges because of DDR and system data alignment restrictions, backing up hardware counters, and context information, and causing redundant data bandwidth. Accordingly, removing this greatly streamlines the image processing capabilities offered by the image engine 100. To the firmware, the image pipeline 115 operates just like a normal wide strip-based image processor and the hardware of the image pipeline 115 internally manages the micro-column 110 by micro-column 110, or block by block, data management autonomously, thereby removing a significant amount of firmware complexity required by the image engine 100.

The image engine 100 improves conventional column-based image processing techniques by significantly reducing the firmware complexity of managing the image pipeline 115 and associated context switches (not shown). Moreover, the image engine 100 reduces the wasted performance overhead by eliminating all the saving and restoration of the image data 20 on every column 135 by utilizing non-overlapping micro-columns 110, thereby reducing the number of redundant fetches of image data 20 to/from the memory device 125 by the image pipeline 115. The number of non-overlapping micro-columns 110 may be, for all intents and purposes, unlimited, and accordingly the image engine 100 supports any number of non-overlapping micro-columns 110. By doing so, the width of the image 105 is not impacted by the processing configuration; e.g., the image engine 100 supports differently-sized print media such as letter size vs. A3 vs. A4, etc., and full-bleed printing, etc. Furthermore, the image engine 100 scales up and down in performance and implementation size, thereby improving processing costs, as needed across various classes of product lines; e.g., low-end to high-end products.

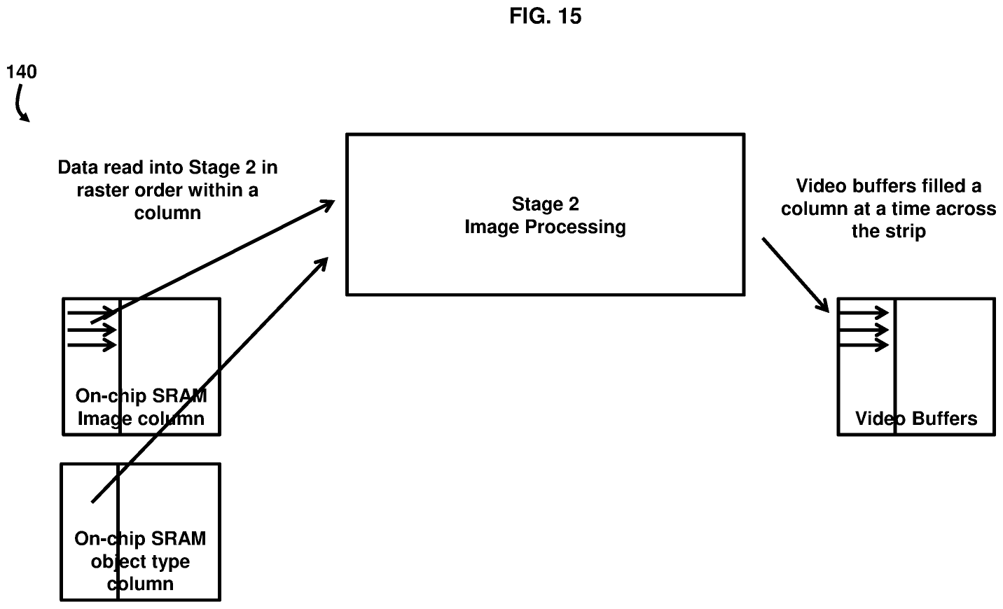

FIG. 15, with reference to FIGS. 1 through 14, illustrates a data processing sequence 140, which may be performed by the processor 45 or image pipeline 115, according to an example. This sequence may align with the Stage 2 processes provided in sequences 96a, 96b of FIGS. 6 and 7, respectively. Data is read into the processor 45 or image pipeline 115 (e.g., Stage 2) in raster order within a micro-column 110. Upon processing by the image pipeline 115, a video buffer may fill a column at a time across the image strip 55.

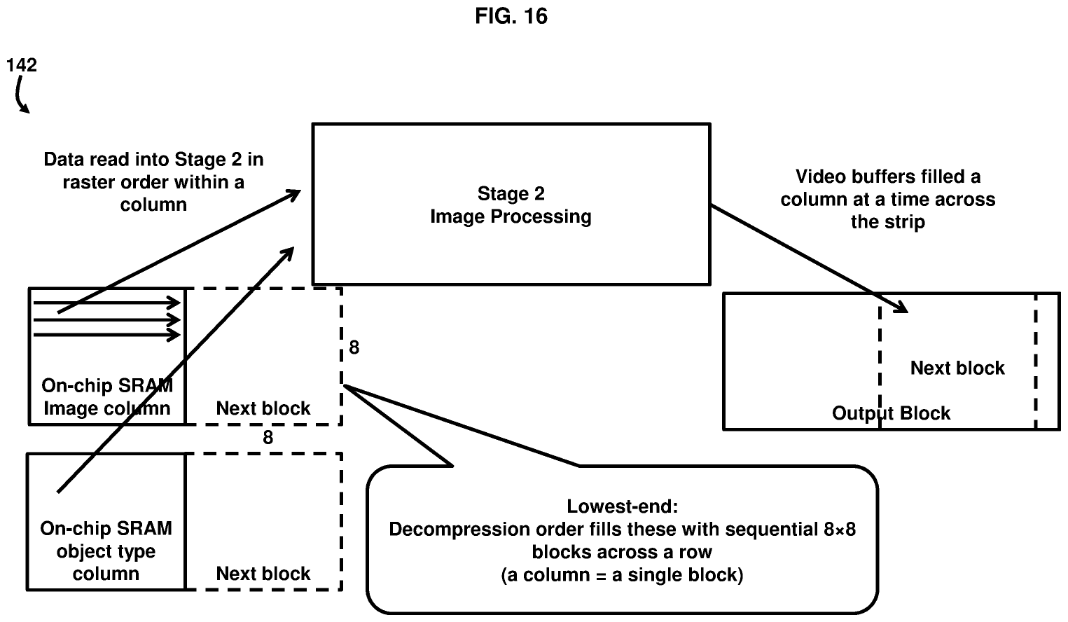

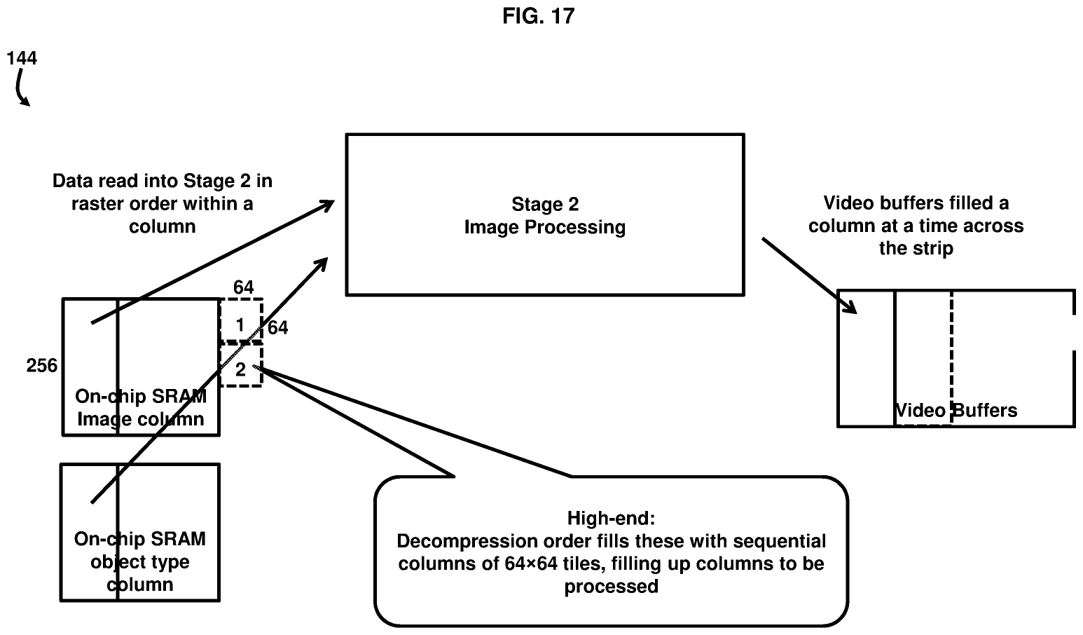

FIG. 16, with reference to FIGS. 1 through 15, illustrates a sequence 142 relating to the Stage 2 processing of FIG. 6 for an example low-end implementation. As shown in FIG. 16, the decompression process fills blocks 35 with sequential 8×8 blocks across a row, wherein a column equals a single block 35. FIG. 17, with reference to FIGS. 1 through 16, illustrates a sequence 144 relating to the Stage 2 processing of FIG. 7 for an example high-end implementation. As shown in FIG. 17, the decompression process fills blocks 35 with sequential columns of 64×64 blocks 35 or tiles 30, filling up the columns to be processed.

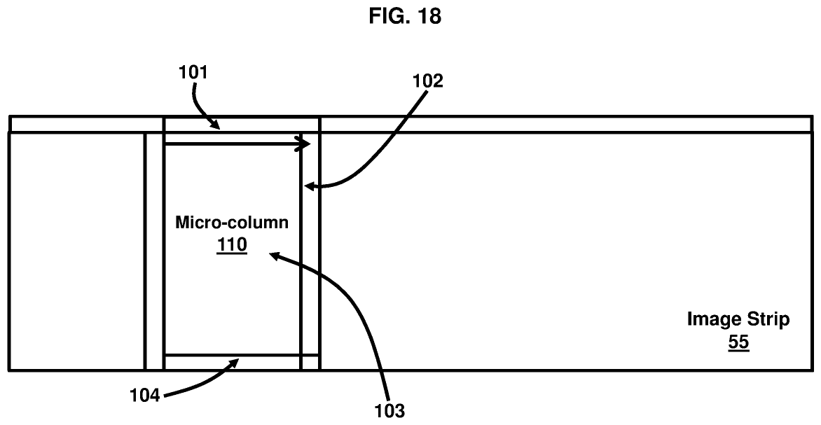

FIG. 18, with reference to FIGS. 1 through 17, depicts the data management that occurs between a micro-column 110 of an image strip 55. In 101, processor 45 or image pipeline 115 automatically reads back the last four line segments for each column before processing to provide context for the column below it. In 102, the last four columns are saved internally on the on-chip memory 60 or circuit chip 130 for the next column window context data 75. In 103, a column of image data 20 is processed in rows up to the last few pixel columns, where the context data 75 ends, and is saved internally on the on-chip memory 60 or circuit chip 130 until the next column of input data is loaded into the processor 45 or image pipeline 115. In 104, the last four rows are automatically stored by the processor 45 or image pipeline 115 for the next restore cycle of this particular color plane.

Various examples described herein may include both hardware and software elements. The examples that are implemented in software may include firmware, resident software, microcode, etc. Other examples may include a computer program product configured to include a pre-configured set of instructions, which when performed, may result in actions as stated in conjunction with the methods described above. In an example, the preconfigured set of instructions may be stored on a tangible non-transitory computer readable medium or a program storage device containing software code.

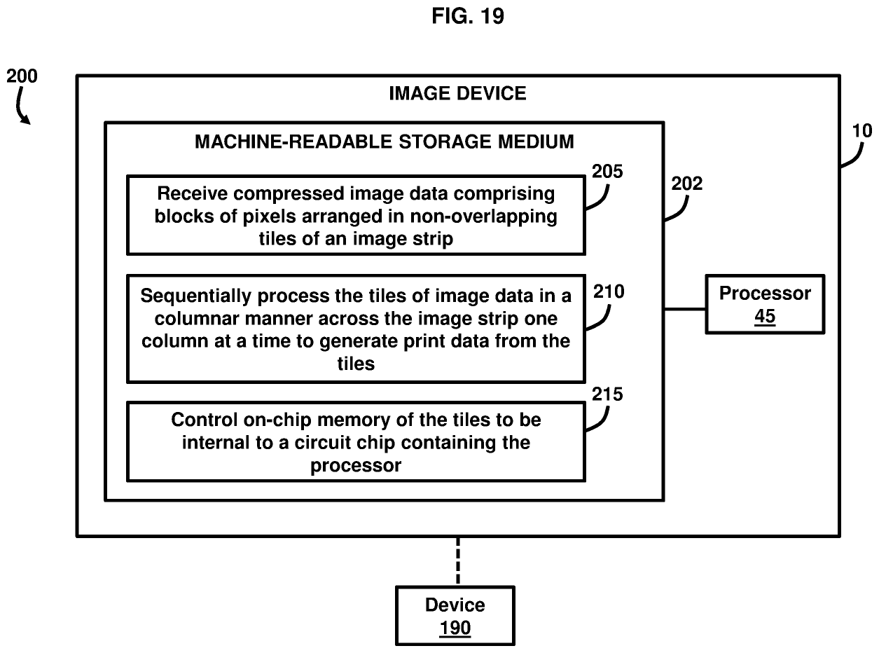

FIG. 19, with reference to FIGS. 1 through 18, illustrates an example system 200 to process image data 20. In the example of FIG. 18, the image device 10 includes the processor 45 and a machine-readable storage medium 202. Processor 45 may include a central processing unit, microprocessors, hardware engines, and/or other hardware devices suitable for retrieval and execution of instructions stored in a machine-readable storage medium 202. Processor 45 may fetch, decode, and execute computer-executable instructions 205, 210, and 215 to enable execution of locally-hosted or remotely-hosted applications for controlling action of the image device 10. The remotely-hosted applications may be accessible on one or more remotely-located devices; for example, device 190. The image data 20 may be data received from device 190 that is external to the image device 10. In this regard, the image data 20 may be considered external data with respect to the image device 10. For example, the device 190 may be a computer, tablet, smartphone, or remote server. In some examples, the image data 20 may be high level image data, such as data in a page description language (PDL), may be sent to the image device 10, and the image device 10 processes the PDL data to generate the image data 20. Alternatively, or in addition to receiving the image data 20 externally from the image device 10, the image data 20 may be received from a source internal to the image device 10, and may be stored, for example, in memory 85. In an example, the source may comprise an optical scanner that is included in the image device 10; e.g., in a multifunction printing/scanning/copying device. As an alternative or in addition to retrieving and executing instructions, processor 45 may include one or more electronic circuits including a number of electronic components for performing the functionality of one or more of the instructions 205, 210, and 215.

The machine-readable storage medium 202 may be any electronic, magnetic, optical, or other physical storage device that stores executable instructions. Thus, the machine-readable storage medium 202 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 202 may include a non-transitory computer-readable storage medium. The machine-readable storage medium 202 may be encoded with executable instructions for enabling execution of remotely-hosted applications accessed on the one or more remotely-located devices 190.

In an example, the processor 45 of the image device 45 executes the computer-executable instructions 205, 210, and 215. For example, computer-executable receiving instructions 205 may receive compressed image data 20 comprising blocks 35 of pixels 40 arranged in non-overlapping tiles 30 of an image strip 55. Computer-executable processing instructions 210 may sequentially process the tiles 30 of image data 20 in a columnar manner across the image strip 55 one column 135 at a time to generate print data 21 from the tiles 30. In some examples a column 135 may be ½, ⅓, ¼, etc. of a page (e.g., print medium 22). Computer-executable controlling instructions 215 may control on-chip memory 60 of the tiles 30 to be internal to a circuit chip 130 containing the processor 45.

The processor 45 may configure the on-chip memory 60 to store tiles 30 of sizes of at least 8×8 pixel blocks. The processor 45 may perform image compression, decompression, processing, and halftoning in a micro-columnar order across the image strip 55. The processor 45 may prevent the tiles 30 from being stored on memory 85 external to the circuit chip 130. The processor 45 may control the on-chip memory 60 to retain all context switching instructions for sequentially processing the tiles 30 of image data 20.

In some examples, the computer-executable instructions 205, 210, and 215 may be part of an installation package that, when installed, can be executed by the processor 45 to implement the instructions 205, 210, and 215. In such examples, the machine-readable storage medium 202 may be a portable medium, such as a CD, DVD, or flash drive, or a memory maintained by an image processing device from which the installation package can be downloaded and installed. In other examples, the instructions may be part of an application, applications, component, or components already installed on the image device 10 including on the processor 45. In such examples, the machine-readable storage medium 202 may include memory such as a hard drive, solid state drive, or the like. In other examples, the functionalities of any of the computer-executable instructions 205, 210, and 215 may be implemented in the form of electronic circuitry.

The examples described herein provide a technique to improve image processing by providing a scalable architecture in terms of the features and performance to reduce reliance on firmware control over the image processing, which allows the technique to be more streamlined and manageable in terms of utilizing system resources for performing its functions. The scalable architecture allows for the improved performance vs. cost tradeoffs to more seamlessly align with the target product needs; e.g., low-end needs vs. high-end needs, etc. The techniques provided by the examples described herein may be applied to various image processing solutions including print, scan, or other data processing pipelines.

The present disclosure has been shown and described with reference to the foregoing exemplary implementations. Although specific examples have been illustrated and described herein it is manifestly intended that the scope of the claimed subject matter be limited only by the following claims and equivalents thereof. It is to be understood, however, that other forms, details, and examples may be made without departing from the spirit and scope of the disclosure that is defined in the following claims.

What is claimed is:

1. An image device comprising:
a compressor to compress image data from a row-and-column format into non-overlapping tiles comprising blocks of pixels;
a processor to write the blocks of pixels one tile at a time in a column-wise manner across an image strip to create image data; and
an on-chip memory to store the image data.

2. The image device of claim 1, comprising a decompressor to decompress the blocks of pixels.

3. The image device of claim 1, wherein the blocks of pixels are at least 8×8 blocks.

4. The image device of claim 1, wherein the on-chip memory comprises a random-access memory device.

5. The image device of claim 1, wherein the on-chip memory stores block context data to providing contextual information regarding each block of pixels.

6. An image engine comprising:
a compressor to downscale an image into configurable non-overlapping micro-columns of image data arranged on an image strip;
an image pipeline to sequentially process the micro-columns of image data in a columnar manner across the image strip to create print data without utilizing firmware resources to process the image data;
a memory device to store the micro-columns; and
a circuit chip to control the compressor and the image pipeline, and to host the memory device.

7. The image engine of claim 6, wherein the memory device comprises static random-access memory.

8. The image engine of claim 6, wherein the image pipeline sequentially processes the micro-columns in a zig-zag manner.

9. The image engine of claim 8, wherein the image pipeline is to process all context data between columns in the image strip.

10. The image engine of claim 8, wherein each of the non-overlapping micro-columns comprise an equal width.

11. A machine-readable storage medium comprising computer-executable instructions that when executed cause a processor of an image device to:
receive compressed image data comprising blocks of pixels arranged in non-overlapping tiles of an image strip;
sequentially process the tiles of image data in a columnar manner across the image strip one column at a time to generate print data from the tiles; and
control on-chip memory of the tiles to be internal to a circuit chip containing the processor.

12. The machine-readable storage medium of claim 11, wherein the processor is to configure the on-chip memory to store tiles of sizes of at least 8×8 pixel blocks.

13. The machine-readable storage medium of claim 11, wherein the processor is to perform image compression, decompression, processing, and halftoning in a micro-columnar order across the image strip.

14. The machine-readable storage medium of claim 11, wherein the processor is to prevent the tiles from being stored on memory external to the circuit chip.

15. The machine-readable storage medium of claim 11, wherein the processor is to control the on-chip memory to retain all context switching instructions for sequentially processing the tiles of image data.
